(19) United States
(12) Patent Application Publication
(10) Pub. No.: US 2019/0347949 A1
(43) Pub. Date: Nov. 14, 2019

(54) COMPUTER-IMPLEMENTED SYSTEM AND METHODS FOR INDIVIDUAL AND CANDIDATE ASSESSMENT

(71) Applicant: GLF CONSULTING FZ, LLC, Fujeirah (AE)

(72) Inventor: Sallyann Della Casa, Jumeirah (AE)

(73) Assignee: GLF CONSULTING FZ, LLC, Fujeirah (AE)

(21) Appl. No.: 16/517,994

(22) Filed: Jul. 22, 2019

Related U.S. Application Data
(60) Provisional application No. 62/701,798, filed on Jul. 22, 2018.

(51) Int. Cl. G09B 7/00; G06Q 10/06

(52) U.S. Cl. CPC G09B 7/00; G06Q 10/063112

(57) ABSTRACT

A computer-implemented system and methods for individual and candidate assessment are provided which solving the problem of how an individual can systematically build, measure, track, visualize, search, and share intuitive skills concurrently while being cognizant of one's own identity, strengths and weaknesses. The system and methods are able to assist individuals in becoming more mindful of the way that they approach self-learning, skill building, careers and professions and eventually their specialized work. In short, the system and methods are able to overhaul the entire education and workforce reliance on traditional resumes and school transcripts alone as indicators on one's abilities and experiences.

### CROSS REFERENCE TO RELATED APPLICATIONS

This application claims priority to and the benefit of the filing date of U.S. Provisional Application No. 62/701,798, filed on Jul. 22, 2018, entitled “METHODS TO LEARN, MEASURE, VISUALIZE, SEARCH, RANK AND SHARE IDENTITY AND SKILLS”, which is hereby incorporated by reference in its entirety.

### APPENDIX TO THE SPECIFICATION This application contains an appendix labeled as “Appendix_A-efs”. The entire contents of which are hereby incorporated by reference in their entirety.

### FIELD OF THE INVENTION

This patent specification relates to the field of computer implemented competency mapping, education and data processing of individuals, such as employment candidates.

### BACKGROUND

Individuals, such as students, employment candidates, and people interested in their personal growth, are well served by evaluating and expanding their intuitive skills, such as soft skills and 21st century skills. Generally, 21st century skills are abilities which individuals need to succeed in their career(s) during the Information Age. Example 21st century skills include: critical thinking; creativity and creative thinking; collaboration; communication; information literacy; media literacy; technology literacy; flexibility; leadership; initiative; entrepreneurship; productivity; and social skills. Generally, soft skills are personal attributes that enable someone to interact effectively and harmoniously with other people. Example soft skills include: strong work ethic; positive attitude; judgement and decision making; good communication skills; mindfulness; emotional IQ; time management abilities; problem-solving skills; acting as a team player; self-confidence; self-direction; and ability to accept and learn from criticism.

However, it is well known that traditional resumes, school transcripts, personality tests, and other existing individual assessments do not illustrate a full picture of one's true abilities, particularly a person's capabilities or ability to learn. In fact, they commonly fail to take into account a person's inherent strengths and weaknesses and modify modules targeting those strengths and weaknesses. Furthermore, existing individual assessments are unable to provide a learning pathway for intuitive skills and habit building capabilities based on combination of engagement, habit and psychometrics, a ranked searching and sharing capabilities.

The conventional method of recruiting talent often relies on experience and feedback of peers. However, it does not take into account the availability or unavailability of appropriate opportunities for individuals to demonstrate their inherent, unique talent.

Therefore, a need exists for novel computer-implemented systems and methods for individual and candidate assessment. A further need exists for novel computer-implemented systems and methods that are configured to provide computer implemented competency mapping, education and data processing of individuals, such as employment candidates. There is also a need for novel computer-implemented systems and methods that are configured to illustrate a full picture of an individual's true abilities, particularly a person's capabilities or ability to learn. Finally, a need exists for novel computer-implemented systems and methods that are configured to provide a learning pathway for intuitive skills and habit building capabilities based on combination of engagement, habit and psychometrics, a ranked searching and sharing capabilities.

### BRIEF SUMMARY OF THE INVENTION

A computer-implemented system and methods for individual and candidate assessment are provided which solving the problem of how an individual can systematically build, measure, track, visualize, search, and share intuitive skills concurrently while being cognizant of one's own identity, strengths and weaknesses. The system and methods are able to assist individuals in becoming more mindful of the way that they approach self-learning, skill building, careers and professions and eventually their specialized work. In short, the system and methods are able to overhaul the entire education and workforce reliance on traditional resumes and school transcripts alone as indicators on one's abilities and experiences. Additionally, the system comprises a database of mapped intuitive skills and the levels in which they are needed for jobs which may be used to enable a user to build their soft skills specific to a job they may desire current and future.

In some embodiments, a computer implemented system and methods for individual and candidate assessment offers a timer based, habit developing systematic learning system for a user to build soft/21st century skills. It provides benchmarking and measurement of a User's performance also using a 360-degree feedback loop. Benchmarking is achieved by allowing users to access a custom designed behavior psychometric tool that builds individual competency grids that map motivations, values, attitudes and personality factors. This benchmarking allows for an individual learning pathway to be designed for each individual learner that focuses on strengthening their most prominent skills and improving their least prominent skills. A user or third party can track and visualize a User's progress/habits in learning soft/21st century skills. A User can also share his rankings and can be found by third parties in searches of soft/21st century skills based on rankings. This method allows a User to Benchmark, Build, Measure, Track, Visualize, Search and Share their soft/21st century skills concurrently besides clearly defining a clear identity of strengths and weaknesses for more mindful choice of work and professions.

According to one embodiment consistent with the principles of the invention, a computer-implemented individual assessment method is provided. In some embodiments, the method may include the steps of: providing a learning individual with an assessment having questions for ascertaining the intuitive skills of the learning individual; generating an individual competency grid of the intuitive skills of the learning individual; comparing the intuitive skills of the learning individual to a jobs and skills map data record; and determining the fitment of the learning individual to a job associated with the jobs and skills map data record.

In further embodiments, the method may include the step of ranking the intuitive skills of the learning individual in the competency grid.

In still further embodiments, the method may include the step of providing a lesson to a client device of the learning individual.

According to another embodiment consistent with the principles of the invention, a computer-implemented candidate assessment method is provided. In some embodiments, the method may include the steps of: providing each of a number of learning individuals with an assessment having questions for ascertaining the intuitive skills of each of the number of learning individuals; generating an institutional competency grid using the intuitive skills of each of the number of learning individuals; and generating an institutional ranking grid having a ranking for each intuitive skill in the institutional competency grid.

In further embodiments, the method may include the step of providing a lesson to a client device of the number of learning individuals.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts an illustrative example of some of the components and computer implemented methods which may be found in an individual and candidate assessment system according to various embodiments described herein.

FIG. 2—FIG. 2 illustrates a block diagram showing an example of a server which may be used by the system as described in various embodiments herein.

FIG. 3—FIG. 3 shows a block diagram illustrating an example of a client device which may be used by the system as described in various embodiments herein.

FIG. 4—FIG. 4 depicts a block diagram illustrating some applications of a individual and candidate assessment system which may function as software rules engines according to various embodiments described herein.

FIG. 5—FIG. 5 illustrates a block diagram illustrating an example of a system database according to various embodiments described herein.

FIG. 6A—FIG. 6A shows an example of an individual competency grid according to various embodiments described herein.

FIG. 6B—FIG. 6B depicts an example of an institutional competency grid according to various embodiments described herein.

FIG. 6C—FIG. 6C illustrates an example of an institutional competency grid according to various embodiments described herein.

FIG. 7—FIG. 7 shows a block diagram of a computer-implemented method for scoring the intuitive skills of a learning individual according to various embodiments described herein.

FIG. 8—FIG. 8 depicts an example of a jobs and skills map data record according to various embodiments described herein.

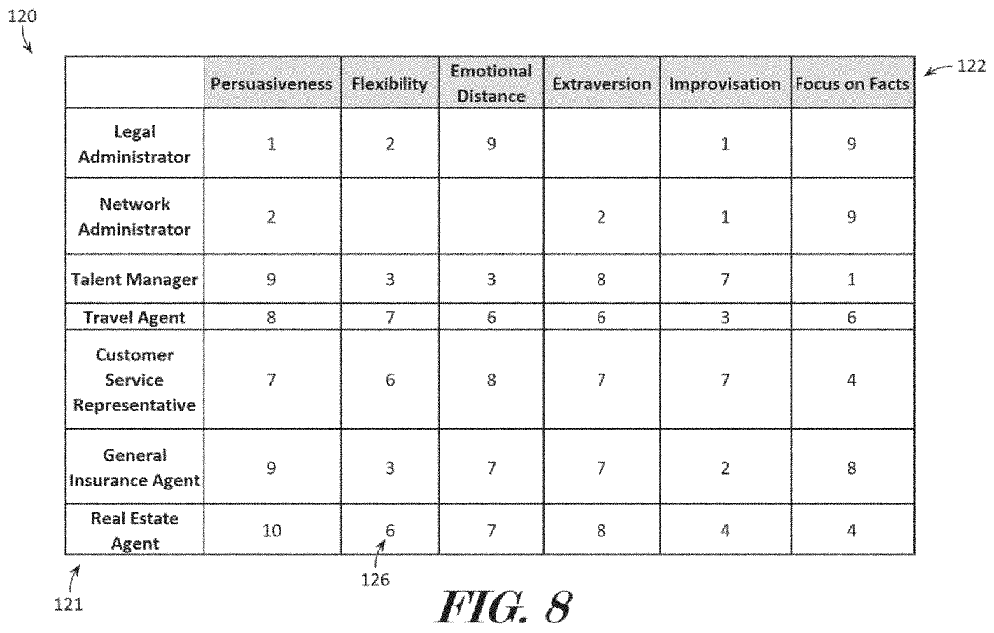

FIG. 9—FIG. 9 illustrates a block diagram of a computer-implemented individual assessment method according to various embodiments described herein.

FIG. 10—FIG. 10 shows a block diagram of a computer-implemented candidate assessment method according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### DEFINITIONS

As used herein, the term “computer” refers to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “electronic device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, servers, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “client device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, servers, laptops, tablet PCs including the iPad, cell phones including iOS phones made by Apple Inc., Android OS phones, Microsoft OS phones, Blackberry phones, Apple iPads, Anota digital pens, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, tablets, digital pens, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigbee network, or a voice-over-IP (VoW) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer-implemented systems and methods for providing competency mapping, education and data processing of individuals, such as employment candidates, are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

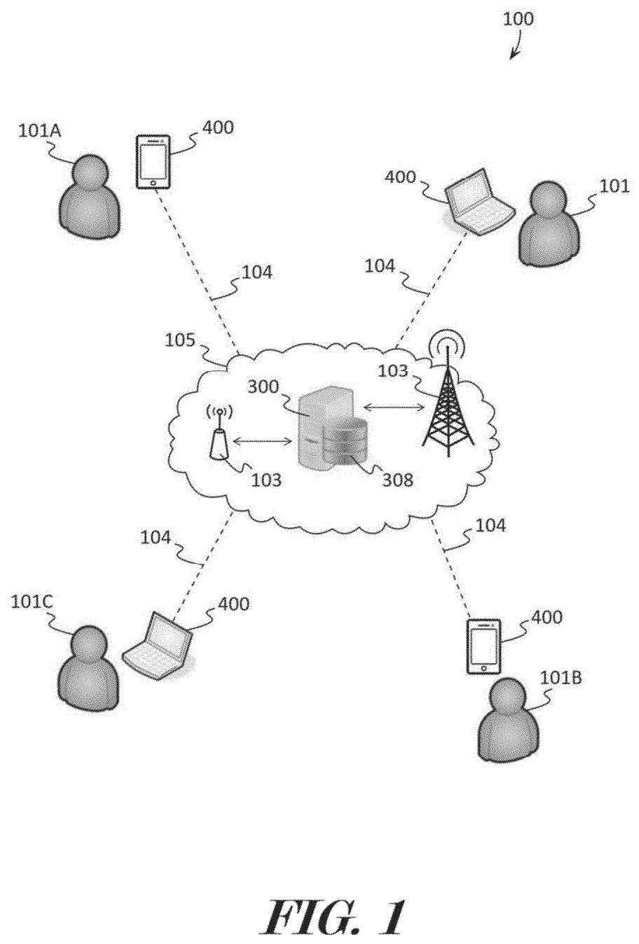

The present invention will now be described by example and through referencing the appended figures representing preferred and alternative embodiments. As perhaps best shown by FIG. 1, an illustrative example of some of the physical components which may comprise an individual and candidate assessment system (“the system”) 100 according to some embodiments is presented. The system 100 is configured to facilitate the transfer of data and information between one or more access points 103, client devices 400, and servers 300 over a data network 105. Each client device 400 may send data to and receive data from the data network 105 through a network connection 104 with an access point 103. A data store 308 accessible by the server 300 may contain one or more databases. The data may comprise any information that one or more users 101 may input into the system 100 including information on or describing one or more users 101, information on or describing one or more intuitive skills of a user 101, information on or describing one or more lessons, quizzes, and jobs, information requested by one or more users 101, information supplied by one or more users 101, and any other information which a user 101 may be provided to a user 101, such as for training, educational, and employment purposes.

Users 101 of the system 100 may include one or more learning individuals 101A and one or more peers 101B. Generally, a learning individual 101A may comprise an individual that may operate a client device 400 for the purposes of exchanging information with the system 100 for the purposes of improving their intuitive skills. Example learning individuals 101A may include students of schools, universities, and organizations, and any other person or individual that desires to achieve self-awareness and self-learning. A peer 101B may comprise an individual that may operate a client device 400 for the purposes of exchanging information with the system 100 for the purposes of providing and/or receiving information on the intuitive skills of one or more learning individuals 101A. Example, peers 101B may include coworkers of a learning individual 101A, fellow students of a learning individual 101A, current employer of a learning individual 101A, and prospective employers of a learning individual 101A.

In this example, the system 100 comprises at least one client device 400 (but preferably more than two client devices 400) configured to be operated by one or more users 101. Client devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one client device 400 and/or server 300 programmed to perform one or more of the steps described herein. In some embodiments, more than one client device 400 and/or server 300 may be used, with each being programmed to carry out one or more steps of a method or process described herein.

In some embodiments, the system 100 may be configured to provide a timer based, habit developing systematic learning environment for a user 101 to build their intuitive skills, such as soft skills and 21st century skills. Generally, 21st century skills are abilities which individuals need to succeed in their career(s) during the Information Age. Example 21st century skills include: critical thinking; creativity and creative thinking; collaboration; communication; information literacy; media literacy; technology literacy; flexibility; leadership; initiative; entrepreneurship; productivity; and social skills. Generally, soft skills are personal attributes that enable someone to interact effectively and harmoniously with other people. Example soft skills include: strong work ethic; positive attitude; judgement and decision making; good communication skills; mindfulness; emotional IQ; time management abilities; problem-solving skills; acting as a team player; self-confidence; self-direction; and ability to accept and learn from criticism.

In further embodiments, the system 100 may be configured to provide benchmarking and measurement of a user's 101 performance and intuitive skills. Benchmarking may be achieved with the use of a customized behavior psychometric tool which may be used to generate individual competency grids mapping user 101 intuitive skills, motivations, values, attitudes and personality factors. Individual learning pathways may then be generated for users 101 to access one or more lessons and quizzes, optionally contained in micro learning modules, to build and improve their intuitive skills. The system 100 may use an algorithm that is balanced and takes into consideration frequency of use, engagement with a daily activity, a 360-degree feedback loop, community performance, benchmark testing on various intuitive skills to give a score to the one or more user's 101. Preferably, a user 101 or third party can track and visualize the user's 101 progress and habits in learning intuitive skills. Optionally, the system 100 may enable a user 101 to also share their rankings and skills progress, and the system 100 may enable this data to be accessible by third parties in searches of intuitive skills, preferably based on rankings. Additionally, the system 100 may comprise a database of mapped intuitive skills and the levels in which they are needed for jobs which may be used to enable a user 101 to build their soft skills specific to a job they may desire current and future.

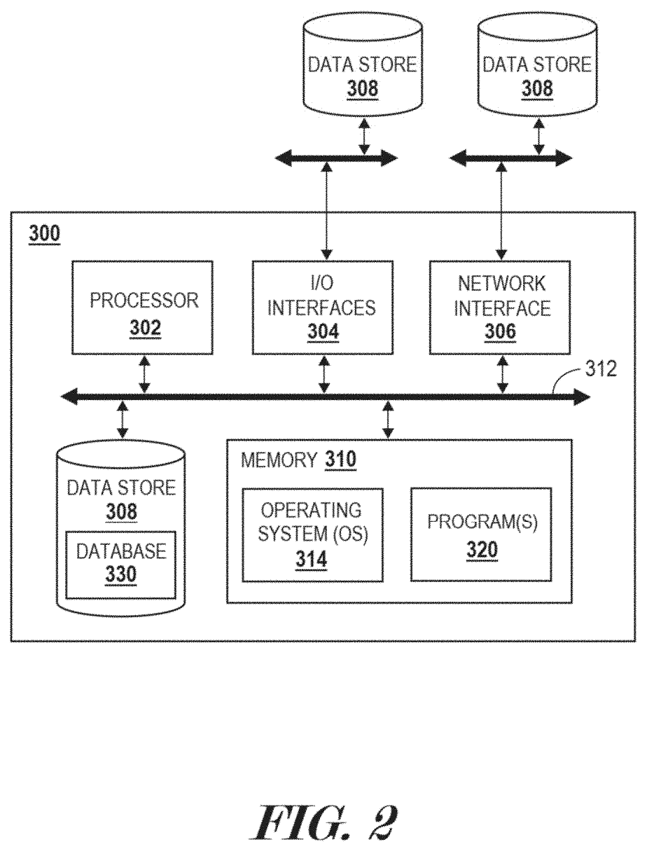

Referring now to FIG. 2, in an exemplary embodiment, a block diagram illustrates a server 300 of which one or more may be used in the system 100 or standalone and which may be a type of computing platform. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10GbE) or a wireless local area network (WLAN) card or adapter (e.g., 802.11a/b/g/n). The network interface 306 may include address, control, and/or data connections to enable appropriate communications on the network. A data store 308 may be used to store data.

The data store 308 is a type of memory and may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally, in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008/2012/2016 (all available from Microsoft, Corp. of Redmond, Wash.), Solaris (available from Sun Microsystems, Inc. of Palo Alto, Calif.), LINUX (or another UNIX variant) (available from Red Hat of Raleigh, NC and various other vendors), Android and variants thereof (available from Google, Inc. of Mountain View, Calif.), Apple OS X and variants thereof (available from Apple, Inc. of Cupertino, Calif.), or the like. The one or more programs 320 may be configured to implement the various processes, algorithms, methods, techniques, etc. described herein.

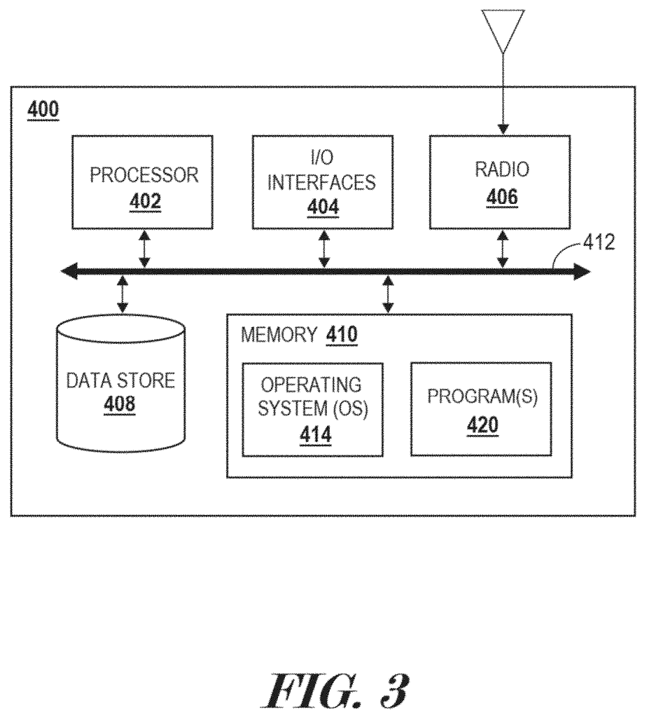

Referring to FIG. 3, in an exemplary embodiment, a block diagram illustrates a client device 400 of which one or more may be used in the system 100 or the like and which may be a type of computing platform. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display screen 404A such as a liquid crystal display (LCD), touch screen, and the like. The I/O interfaces 404 can also include, for example, a global positioning service (GPS) radio, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 408 may be used to store data and is therefore a type of memory. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs 420, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, Microsoft Windows 10, iOS (available from Apple, Inc.), webOS (available from Hewlett Packard), Blackberry OS (Available from Research in Motion), and the like.

The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network 105 to manipulate information of the system 100.

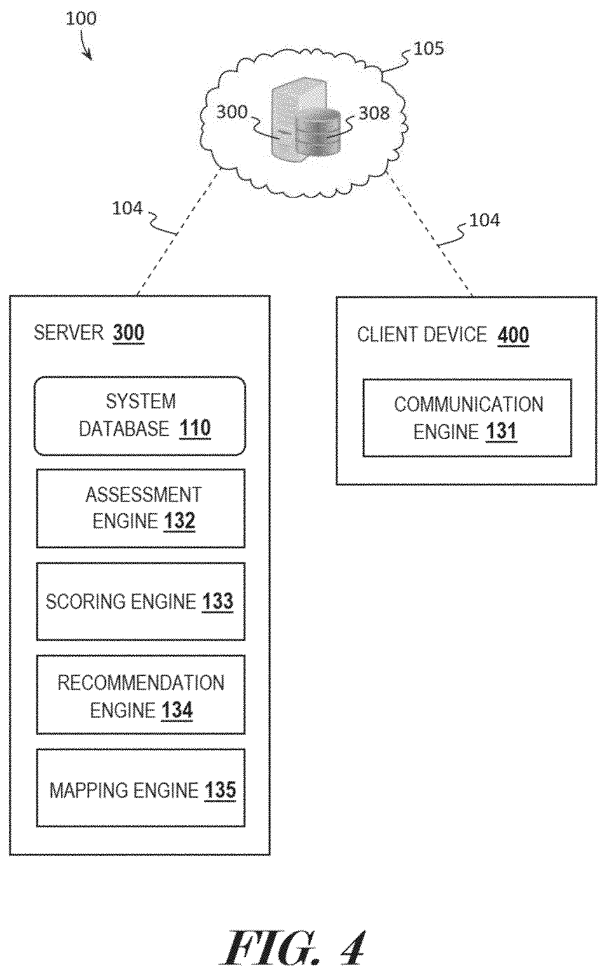

Referring now to FIG. 4 a block diagram showing some software rules engines and components which may be found in a system 100 and which may optionally be configured to run on one or more servers 300 and/or client devices 400 according to various embodiments described herein are illustrated. A server 300 and client device 400 may be in wired and/or wireless electronic communication through a network 105 with a data store 308. The engines 131, 132, 133, 134, 135, may be in electronic communication so that data may be readily exchanged between the engines 131, 132, 133, 134, 135, and one or more engines 131, 132, 133, 134, 135, may read, write, or otherwise access data in one or more system databases 110 of one or more data stores 308.

In this and some embodiments, one or more servers 300 may be configured to run one or more software rules engines or programs such as an assessment engine 132, scoring engine 133, recommendation engine 134, and mapping engine 135 while a client device 400 may be configured to run one or more software rules engines or programs such as a communication engine 131. In other embodiments, a communication engine 131, assessment engine 132, scoring engine 133, recommendation engine 134, and/or mapping engine 135 may be configured to run on one or more client devices 400 and/or servers 300 with data transferred to and from a communication engine 131, assessment engine 132, scoring engine 133, recommendation engine 134, and/or mapping engine 135 that may be in communication with a data store 308 through a network 105. It should be understood that the functions attributed to the engines 131, 132, 133, 134, 135, described herein are exemplary in nature, and that in alternative embodiments, any function attributed to any engine 131, 132, 133, 134, 135, may be performed by one or more other engines 131, 132, 133, 134, 135, or any other suitable processor logic.

The system 100 may comprise one or more communication engines 131. A communication engine 131 may comprise or function as communication logic stored in a memory 310, 410, which may be executable by the processor 302, 402, of a server 300 and/or client device 400. Generally, a communication engine 131 may be configured to operate an I/O interface 404, such as a display screen 404A (optionally of a touchscreen interface), of a client device 400 operated by a user 101 in order to provide and receive information from the user 101 via a graphical user interface, such as via a notepad. In some embodiments, a communication engine 131 may be configured to enable communication between one or more servers 300 and client devices 400. In further embodiments, a communication engine 131 may be configured to push notifications of lessons 111 available for a learning individual 101A to the client device 400 of the learning individual 101A. In further embodiments, a communication engine 131 may be configured to send or provide user intuitive skill 118 scores 125, rankings, and learning habits to any third party, in any format including social media platforms, such as Facebook and Instagram, and hiring and networking platforms, such as LinkedIn, Monster, etc. In still further embodiments, a communication engine 131 may be configured to operate any of the I/O interfaces 404 of a client device 400 to allow the system 100 to input and output information from and to a user 101 via a client device 400.

The system 100 may comprise one or more assessment engines 132. An assessment engine 132 may comprise or function as assessment logic stored in a memory 310, 410, which may be executable by the processor 302, 402, of a server 300 and/or client device 400. In some embodiments, an assessment engine 132 may be configured to select and retrieve one or more quizzes 113, questions 114, and lessons 111 from a system database 110 which may be provided to the client device 400 of a learning individual 101A by a communication engine 131. In further embodiments, an assessment engine 132 may be configured to score quizzes 113, notepad interactions, and other input provided by a learning individual 101A via their client device 400.

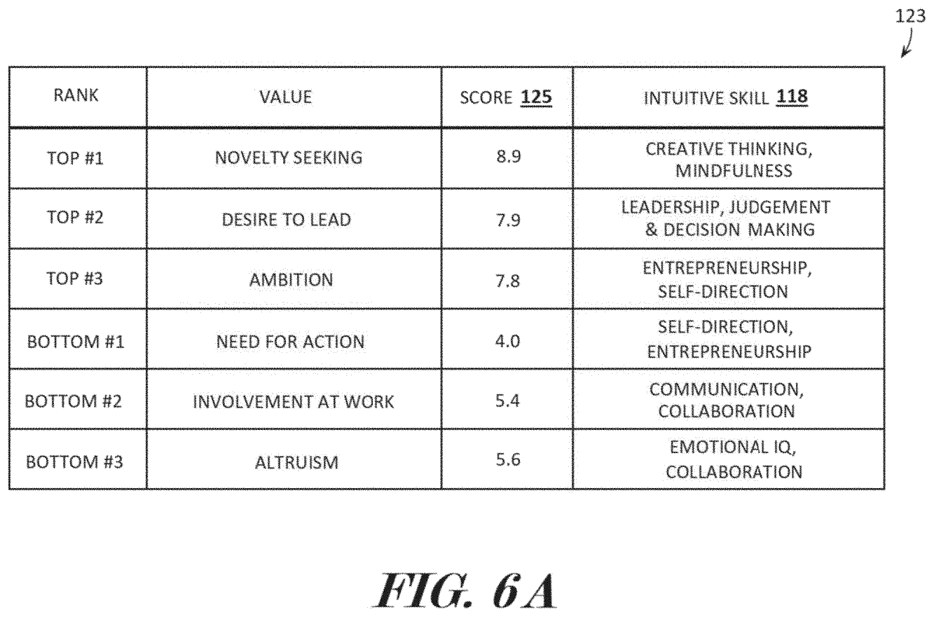

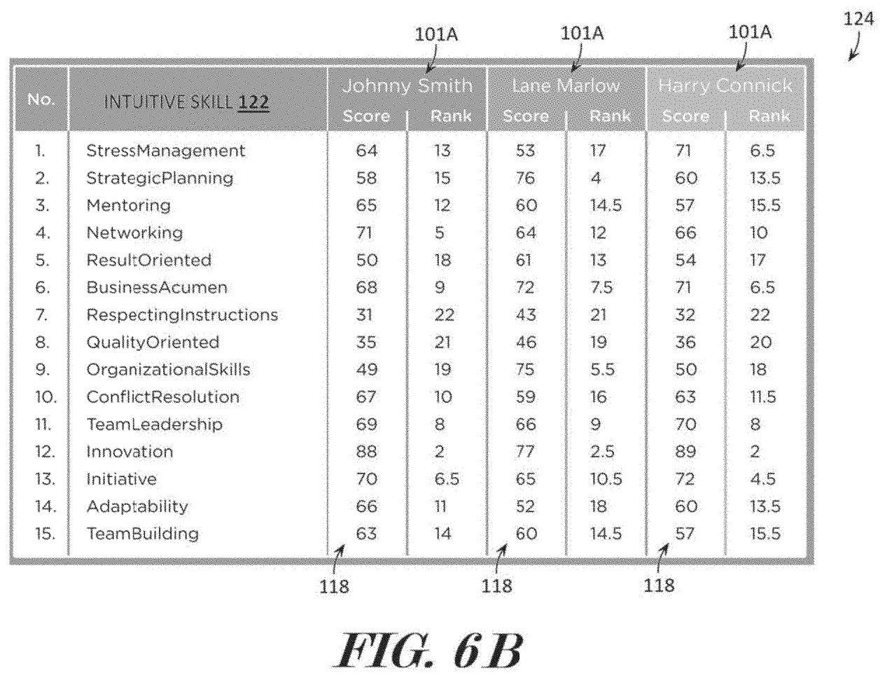

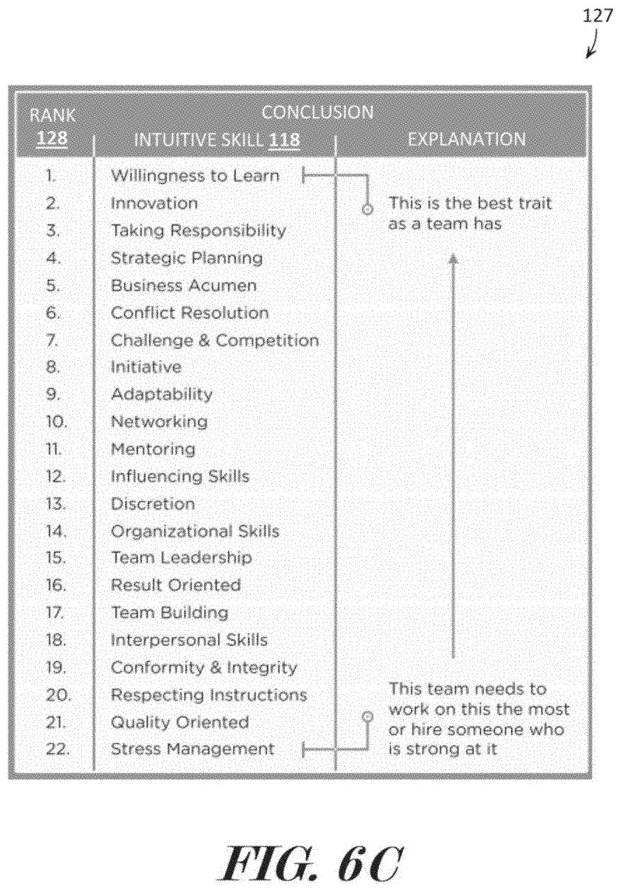

The system 100 may comprise one or more scoring engines 133. A scoring engine 133 may comprise or function as scoring logic stored in a memory 310, 410, which may be executable by the processor 302, 402, of a server 300 and/or client device 400. In some embodiments, a scoring engine 133 may be configured to score a learning individual's 101A input that they provide in response to activities 112, quizzes 113, and lessons 111 via a communication engine 131. In further embodiments, a scoring engine 133 may be configured to score a peer's 101B input that they provide in response to queries about the intuitive skills 118 of a learning individual 101A via a communication engine 131. In further embodiments, a scoring engine 133 may be configured to generate an individual competency grid 123 (a compentency grid showing intuitive skills 118 of a single learning individual 101A) using the individual's 101A intuitive skills 118 scores 125 as shown in FIG. 6A. In some embodiments, a scoring engine 133 may be configured to generate an institutional competency grid 124 of two or more learning individual's 101A intuitive skills 118 scores 125 in an organization, such as for each employee in a group, department, or company as shown in FIG. 6B.

The system 100 may comprise one or more recommendation engines 134. A recommendation engine 134 may comprise or function as recommendation logic stored in a memory 310, 410, which may be executable by the processor 302, 402, of a server 300 and/or client device 400. In some embodiments, a recommendation engine 134 may be configured to select one or more activities 112, lessons 111, and quizzes 113 which may be provided to a learning individual 101A based on the intuitive skills 118 and scores 125 of the learning individual 101A. In further embodiments, a recommendation engine 134 may be configured to create one or more learning pathways 119 which may comprise one or more activities 112, lessons 111, and quizzes 113 for a learning individual 101A to perform or receive. In further embodiments, a recommendation engine 134 may be configured to recommend jobs 121 for a learning individual 101A based on the intuitive skills 118 and scores 25 of the learning individual 101A.

The system 100 may comprise one or more mapping engines 135. A mapping engine 135 may comprise or function as mapping logic stored in a memory 310, 410, which may be executable by the processor 302, 402, of a server 300 and/or client device 400. In some embodiments, a mapping engine 135 may be configured to map job intuitive skills 122 and scores 126 to jobs 121. In further embodiments, a mapping engine 135 may be configured to map job intuitive skills 122 and scores 126 to jobs 121 which may be listed on third party employment platforms, such as LinkedIn, Monster, Indeed, and the like.

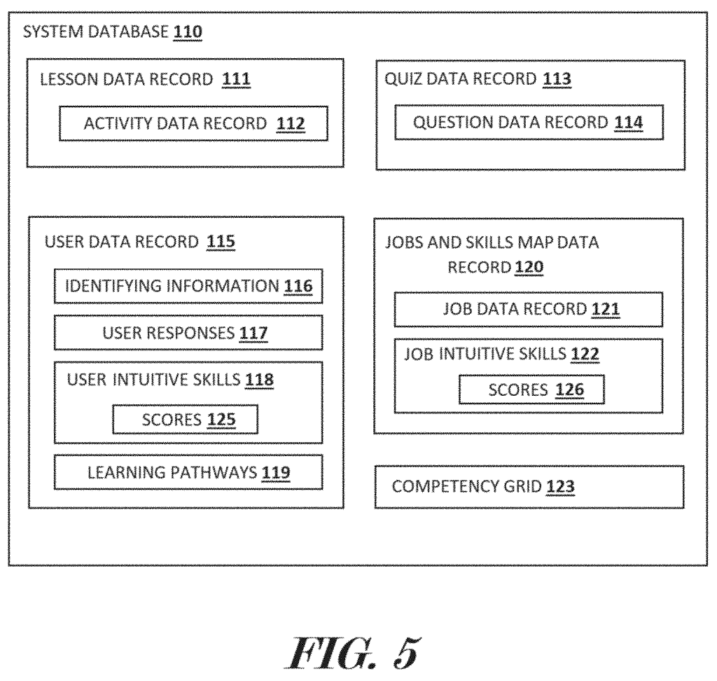

Turning now to FIG. 5, the system 100 may comprise one or more databases, such as a system database 110, which may be stored on a data store 308 accessible to one or more engines 131, 132, 133, 134, 135. In some embodiments, a system database 110 may comprise information that one or more users 101 desire to input into the system 100 including information provided by one or more users 101, such as information on or describing one or more intuitive skills 118 and scores 125 of users 101, information in response to one or more activities 112, lessons 111, quizzes 113, and queries, information on or describing one or more job intuitive skills 122 and scores 126, information on or describing one or more jobs 121, information on or describing one or learning pathways 119, and any other information which a user 101 may provide or be provided with for the purposes of promoting behavioral change and improving the focused attention daily of the users 101. It should be understood that the described structure of the system database 110 is exemplary in nature, and that in alternative embodiments, the data contained within the system database 110 may be organized in any other way.

In some embodiments, a system database 110 may comprise one or more, such as a plurality of, lesson data records (“lessons”) 111. Generally, a lesson 111 may comprise one or more activity data records (“activities”) 112 which may be provided to a learning individual 101A and which the learning individual 101A may interact with, such as via a virtual notepad, keyboard, and/or other I/O interface 404A in order to maintain or improve an intuitive skill of the learning individual 101A. For example, an activity 112 may comprise a game, written passage, video, etc., which a learning individual 101A may play, read, watch, etc., to improve the intuitive skill of critical thinking.

In some embodiments, a system database 110 may comprise one or more, such as a plurality of, quiz data records (“quizzes”) 113. Generally, a quiz 113 may comprise one or more question data records (questions”) 114 which may be provided to a learning individual 101A for the purposes of ascertaining one or more intuitive skills or other information of the learning individual 101A, preferably based on one or more lessons 111 provided to the learning individual 101A. A learning individual 101A may provide input in response to the questions 114 via a virtual notepad, keyboard, and/or other I/O interface 404A and the input may be scored in order to ascertain one or more intuitive skills of the learning individual 101A.

In some embodiments, a system database 110 may comprise one or more, such as a plurality of, user data records 115. Generally, a user data record 115 may comprise information describing a user 101, such as a learning individual 101A or a peer 101B. In some embodiments, user data records 115 may comprise one or more data fields, such as identifying information 116, user responses 117, user skills 118, and learning pathways 119. Identifying information 116 may include a name, a user name, password, other login information, physical address, email address, phone number, client device 400 information, or any other information which may be used to identify the user 101 of the user data record 115. User responses 117 may include input provided by the user 101 in response to lesson 111 queries or questions, activity 112 queries or questions, quiz 113 queries or questions, and any other queries or questions. User skills 118 may describe the level of one or more intuitive skills, rate of change or progress over time of one or more intuitive skills, and any other information which may be used to measure and describe the intuitive skills of the user 101. Learning pathways 119 may describe one or more lessons 111, activities 112, quizzes 113, and any other information which may be provided to the user 101 in order to improve or maintain one or more intuitive skills.

In some embodiments, a system database 110 may comprise one or more, such as a plurality of, jobs and skills map data records (jobs and skills maps)120. Generally, a jobs and skills map 120 may comprise one or more jobs 121 with one or more job intuitive skills 122 and a score 126 preferably for each job intuitive skill 122 associated with each job 121. A job data record (“job”) 121 may comprise information describing a job, position, role, occupation, task, and the like, which a person, such as a user 101, may perform. An intuitive skill data record (“job intuitive skill”) 122 may comprise information describing an intuitive skill 122 which may be used and/or not used by an individual performing that job 121. In preferred embodiments, the system database 110 may comprise an individual competency grid 123 for each learning individual 101A which may comprise a listing of two or more intuitive skills 122 of the learning individual 101A and a measurement or score 126 for each intuitive skill 122. Preferably, the score 126 for each intuitive skill 122 of a job 121 may describe a threshold value or minimum value that a user intuitive skill 118 score 125 should preferably meet or exceed to successfully perform the job 121. In further embodiments, the system database 110 may comprise a plurality of jobs and skills map 120 data records which may function as a database of mapped intuitive skills 122 and the levels or scores 126 in which they are needed for jobs 121 which may be used to provide one or more lessons 111, activities 112, quizzes 1113, which may be used by a learning individual 101A to build their user intuitive skills 118 (and scores 125) specific to a job 121 they may desire current and future, preferably so that the user intuitive skills 118 scores 125 meet or exceed the scores 126 for each intuitive skill 122 associated in the jobs and skills map 120 data record of that job 121.

In some embodiments, the system 100 may enable a learning individual 101A to use their client device 400 to Build, Measure, Track, Visualize, Search and Share their intuitive skills 118 and scores 125 concurrently.

In some embodiments, a plurality of lessons 111, in various intuitive skills 118 categories may be uploaded to the system database 110, optionally on a server 300, and the lessons 111 may be available for completion by learning individual 101A on various time intervals, such as one per day or for a 24-hour time span, two per week, or any other time period, via various digital client devices 400, such as computers, tablets, laptops, smartphones, and the like. In some embodiments, a learning individual 101A may have a limited time period to complete a lesson 111, such as ten minutes, to work on an activity 112, and/or complete a quiz 113. In preferred embodiments, the communication engine 131 may send push notifications to the client device 400 of a learning individual 101A, such as two times a day, reminding the learning individual 101A about the time they have before the lessons 111, activities 112, and/or quizzes 113 expires (so as to be unavailable to the user 101 and/or unavailable for scoring purposes).

In preferred embodiments, each activity 112 may require a learning individual 101A to use a virtual notepad, which may be implemented as a space on the client device 400 display screen 404A which the user learning individual 101A can access with their keyboard, digital pen, finger touch, etc., to write their answers and thoughts regarding the lesson 111 and activities 112 being offered on that day, built into the system 100 to respond. In preferred embodiments, the assessment engine 132 may comprise a timer that clocks the engagement on each activity 112 of the learning individual 101A. Upon completion of an activity 112 the learning individual 101A may have the option to answer questions 114 in a self-review and also have the option to send to another user 101, such as a peer 101B, by inputting or selecting their email, name, phone number, or other unique identifier and sending a request for a peer review on the intuitive skill(s) 118 being practiced on that day.

In some embodiments, a scoring engine 133, over a time frame such as daily, weekly, monthly and/or quarterly period, may calibrates a score 125 for one or more intuitive skills 118, preferably on a competency grid 123, for each learning individual 101A. This score may be based on an algorithm that takes into consideration the learning individual's 101A frequency of use, engagement, reviews, feedback loop (an opportunity for a learning individual 101A to self-evaluate themselves on the intuitive skills 118 being practiced that day with a series of questions 114) and also an opportunity for the learning individual 101A to select a peer 101B to also evaluate them on this same intuitive skills 118 using a different set of questions 114 than the ones the learning individual 101A self-evaluated themselves on.

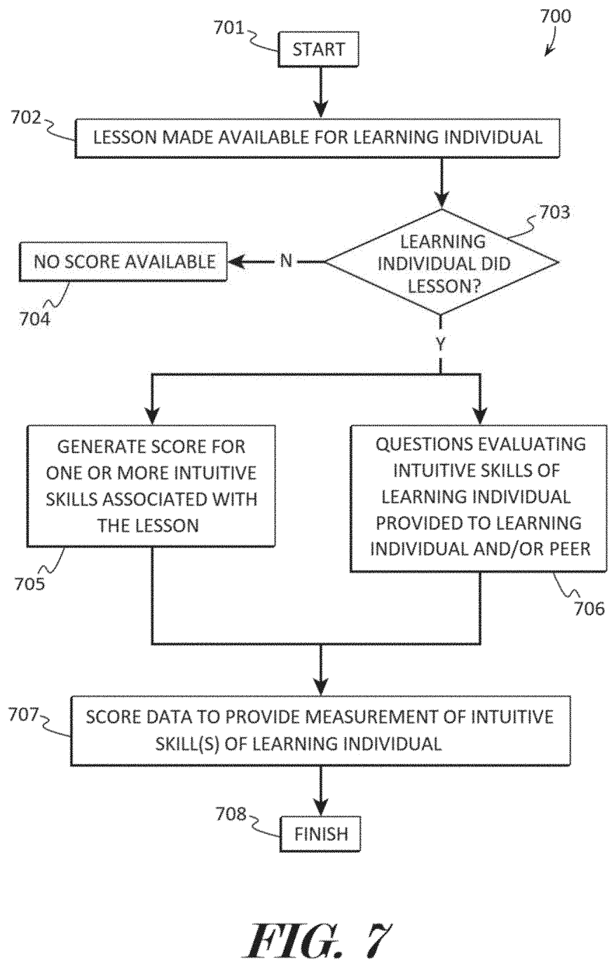

FIG. 7 depicts an example method for scoring the intuitive skills 118 (assigning a score 125) of a learning individual 101A (“the method”) 700 according to various embodiments. One or more steps of the method 700 may be performed by a communication engine 131, assessment engine 132, scoring engine 133, recommendation engine 134, and/or mapping engine 135 which may be executed by a computing device processor, such as a processor 302 (FIG. 2) and/or a processor 402 (FIG. 3).

In some embodiments, the method 700 may start 701 and a lesson 111 may be made available for the learning individual 101A in step 702. In preferred embodiments, the client device 400 of the learning individual 101A may output a message that a new lesson 111 available via a communication engine 131. For example, lessons 111 may be released every 24 hours. Lessons 111 may comprise or be associated with one or more activities 112 and quizzes 113. Preferably, each activity 112 may require a time period of engagement, such as up to 10 minutes of engagement or any other time period.

In decision block 703, the assessment engine 132 may determine if the learning individual 101A did the lesson 111 using user input provided by the client device 400 of the learning individual 101A. Preferably, a learning individual 101A spends time doing activity 111 and the assessment engine 132 measures time spent and engagement on a virtual notepad or other input method. If the learning individual 101A did not do the lesson 111, the method 600 may continue to step 704 in which no score is available, and the method 700 may finish 708.

If the learning individual 101A did do the lesson 111, the method 700 may continue to steps 705 and 706. In step 705, the scoring engine 133 may use the input of the learning individual 101A to generate a score 125 for one or more intuitive skill 118 associated with the lesson 111. For example, the scoring engine 133 may use input such as, the amount of time spent, the number of types words, if all questions 114, were answered, if information was sent to a peer 101B, if the peer 101B answered all questions 114, if the lesson 111 was downloaded or otherwise accessed, and any other information provided by the learning individual 101A in response to the activities 112 and quizzes 113 of the lesson 111. In step 706, one or more questions 114 may be provided to the learning individual 101A for self-evaluation and preferably one or more questions 114 may be provided to peer(s) 101B selected by the learning individual 101A for the purposes of evaluating the intuitive skills 118 of learning individual 101A. This allows the learning individual 101A to have the opportunity to do a self- review and a peer 101B review of that intuitive skill 118 being practiced on that day.

In step 707, the data of steps 705 and 706 may be scored to provide a measurement or score 125 of the intuitive skill(s) 118 of the learning individual 101A. In preferred embodiments, the scoring engine 133 may compare the input of the learning individual 101A to the input of the peer 101B of step 706 to determine a score 125 of the intuitive skill 118. Preferably, the total score 125 is then weighed using a desired algorithm and a final percentage or other measurement is assigned to the learning individual 101A for the intuitive skill 118 being practiced. In further embodiments, the scoring engine 133 may review and adjust the intuitive skill 118 rating or score 125 based on a bell curve or other form of data fitting of the community tied to random testing of benchmarking/recognized intuitive skill 118.

In some embodiments, once the learning individual 101A has a score 125 for one or more intuitive skills 118, the scoring engine 133 may visualizes and displays these scores 125 in a competency grid 123 on the display 404A of the client device 400 similar to the example of FIG. 6A. This competency grid 123 may be shared to anyone via various avenues, such as alongside any documents, which can include a resume, school transcripts, etc. in the profile of the learning individual 101A. In further embodiments, a competency grid 123 may also be shared as a standalone document via social media profiles, such as LinkedIn, etc., employment platforms, such as Indeed, etc., or any other means. In this manner, a learning individual 101A may choose to make their intuitive skills 118 scores 125, learning pathways 119, documents uploaded, or any other information public so they may be searchable by employers via this data. The scores of a learning individual 101A as well as any related data or results may be stored in one or more system databases 110, such as on a cloud based server 300. After step 707, the method 700 may finish 708.

In some embodiments, the system 100 may enable a learning individual 101A to accomplish various tasks which may include: finding a job 121 that matches their intuitive skills 118; improve their abilities in one or more intuitive skills 118, show more information about their abilities and intuitive skills 118 other than what is shown on a resume and/or school transcript etc. In further embodiments, the system 100 may further be scaled to aid recruitment organizations and organization in benchmarking candidates in intuitive skills 118, such as soft skills and 21^{st} century skills.

Various uses of the system 100 may include school systems imbedding the system 100 to create a more comprehensive report card for students, which includes intuitive skills 118 and their scores 125. Job recruitment companies/portals or employment platforms such as LinkedIn, Monster, etc., may also imbed the system 100 so users 101 can show their profiles and scores of soft/21^{st} century skills to give a truer picture of their abilities. Organizations can also utilize the system accessing a customized dashboard to build and track intuitive skills 118 of their workforce that ties to a company ROI on training and development.

In some embodiments, a communication engine 131 of the system 100 may generate a web based graphical user interface allowing a user 101 to interact with the system 100 via a web-browser. In other embodiments, one or more users 101 may interact with the system 100 via an application (an “app”), which may be downloaded to their client device 400.

FIGS. 6A and 6B illustrate the use of the behavioral psychometric test and its implication on the habit building micro-learning as well as its use for institution level decision making. FIG. 6A shows an example of an individual competency grid 123, which may be generated by a scoring engine 133, drawn from the conclusions from the learning individual's 101A behavioral psychometric test. The top three user intuitive skills 118 coincide with the learning individual's 101A most prominent skills 118 (having the highest scores 125) while the bottom three user intuitive skills 118 coincide with the learning individual's 101A least prominent skills 118 (having the lowest scores 125). Based on this combination of highest and/or lowest scores 125, a learning pathway 119 may be designed by the recommendation engine 134 to reinforce the most prominent skills 118 and strengthen the least prominent skills 118 through daily, weekly, or any other time interval practice of micro-learning modules comprising one or more lessons 111, activities 112, and quizzes 113 via their client device 400. It should be understood that an individual competency grid 123 and an institutional competency grid 124 may comprise any number of intuitive skills 118 and scores 125.

FIG. 6B, depicts an example of an institutional competency grid 124, which may be generated by a scoring engine 133, showing the user intuitive skills 118 and scores 125 of three learning individuals 101A. In some embodiments, and in this example, an institutional competency grid 124 may rank each individual member of the organization (learning individual 101A) under each intuitive skill 118. FIG. 6C shows an example of an institutional ranking grid 127, which may be generated by a scoring engine 133. In some embodiments, a scoring engine 133 may generate an average organization score or ranking 128 for each intuitive skill 118 and/or category of intuitive skills 118 of the one or more learning individuals 101A in the institutional competency grid 124. Based on these organization level scores or rankings 128, a preliminary debrief may be prepared to guide the organization to reinforce their most prominent intuitive skills 118 and strengthen their least prominent intuitive skills 118.

In some embodiments, the system 100 may be configured to map the user intuitive skills 118 that a learning individual 101A has to needs to the job intuitive skills 122 of one or more jobs 121 using the jobs and skills map data records 120. For example, a learning individual 101A named JANE wants to be a lawyer (in this example the job 121 would be lawyer). The recommendation engine 134 may output a report showing how Jane's intuitive skills 118 are below, equal to, and/or above the job intuitive skills 122 of that lawyer job 121 using the jobs and skills map data records 120 of the lawyer job 121. First, Jane may take or perform an assessment, such as a British Psychology Approved Benchmark which maps 200 plus behaviors to jobs. The reports compares her intuitive skills 118 to the job intuitive skills 122 to output her fitment for the lawyer job 121.

Jane may also want to know what 21 century/soft skills she may need for the role.

In some embodiments, the user intuitive skills 118 may comprise 10 skills at varying levels to different combination of behaviors desired for job roles. For example, Persuasion as a behavior 21 century/soft skill is Communication as a user intuitive skill 118. Thinking on your Feet as a Behavior century/soft skill is Creativity as a user intuitive skill 118. Reflection as a behavior 21 century/soft skill is Mindfulness as a user intuitive skill 118. Extraversion as a Behavior 21 century/soft skill is Collaboration as a user intuitive skill 118.

In preferred embodiments, user intuitive skills 118 may comprise: Collaboration, Critical Thinking, Creativity, Communication, Emotional IQ, Creativity, Judgement and Decision making, Leadership, Self-Direction and Mindfulness.

Jane keeps reading lawyer's jobs may become automated and wants to explore if there are other jobs requiring the same soft skills needed for a lawyer role or some future job to be created.

Next, the mapping engine 135 may reference the jobs and skills map data records 120 which comprises the descriptions of activities to be performed under those existing job roles in the British Psychology approved Benchmark in order to map similar job existing and future job descriptions. In some instances, job roles may be combined because a future job such as a HR/AI Integrator may require a combination of several existing job roles.

In some embodiments, the system 100 may be configured to accurately measure human skills and behaviors for job roles and culture fit and a candidate's or learning individual's 101A fitment to that role and culture. Continuing the above example, Jane has the highest scores of the DC Bar. She applies for a job as a litigation lawyer at the finest litigation firm and the Firm wants to verify her human skills and behaviors for the job of a lawyer after reviewing her user intuitive skills 118 compared to the job intuitive skills 122 of a litigation lawyer job 121.

Preferably, the system database 110 may comprise the user intuitive skills 118 associated with the behaviors needed for each job 121 type and also includes 25 or any number of situational judgement lesson for specific workplaces and sectors such as IT, high growth company, Retail, hospitality brand, etc.

The company sends situational judgement scenarios to Jane's client device 400 where certain user intuitive skills 118 would apply. Jane, may use her client device 400 to type in or records her responses of how she would handle each workplace situation applying user intuitive skills 118.

Jane's responses may be assigned a quantitative, qualitative and 360 feedback loop score using machine learning algorithms.

In this manner, the system 100 provides a starting point of the human skills and behaviors needed for a job and where they stand after taking the benchmark. The user intuitive skills 118 mapped to their top 3 and bottom 3 behaviors are now shuffled daily for them to take micro-learning lessons (such as 5-10 minutes long) to explore culture fit, improve or develop further these skills for the desired job.

The system 100 may also allow the Company to check the culture fit of a learning individual 101A to a job 121.

Continuing the above example, the company compares Jane's behavioral benchmark and situational judgement responses against the competency map of its workforce, top performers (learning individuals 101A) and lowest performing employees (learning individuals 101A) and maps Jane on a curve for the role she is applying for and also other roles within the company culture where she may have a better fitment.

After running Jane through the process, the system 100 shows that Jane is better fitted behaviorally for a HR Litigation Research Lead Role in the company based on her user intuitive skills 118. Her user intuitive skills 118, such as Judgement and Decision Making, Thinking on her Feet coupled with her organizational skills, attention to details and critical thinking equals those in the law firm thriving and performing at optimal level in this role in the law firm. Jane's introversion, need to reflect, rule following tendencies and weak persuasion skills does not make her an optimal litigation attorney.

In some embodiments, the system 100 may enable a company to find out culture fit of the human behaviors and skills of a candidate. For example, a benchmark assessment may be provided to the client device 400 of the top and bottom performing employees of a company. The results of the benchmark may be used to create a template of what good and bad behaviors are within this company culture. User intuitive skills 118 may be assigned to these behaviors so a company understand what user intuitive skills 118 are more desired and least desired within this company culture. The scoring engine 133 may generate an institutional competency grid 124 of the similar behaviors of top performers and bottom performers for easy reference. The system 100 may then send the top and bottom employees daily 5 minutes questions where they apply the user intuitive skills 118 and answer via their client devices 400, such as in free text like a whatsup message. The questions sent are chosen from a system database 110 catalogue of questions designed for specific industries and job roles.

The employees (learning individuals 101A) may then answer the questions. The scoring engine 133 may labels the answers of top and bottom performers for keywords, and the scoring engine 133 may perform a similarity check to see how close someone's answer is to the perfect answer. For example, this score may be from 0-1 with 1 being most similar. The scoring engine 133 may also give a score out of 11 to each answer of the top and bottom performer using our scoring algorithm.

Example Score Calculation:

1 Point if User Spent time >5 Minutes else 0.5

1 Point if characters are greater than 25

1 Point if answer is meaningful (verified by python service)

1 Point if self-review submitted

1 Point if only 1 rating is given 10 on scale of 0-10 else if user has rated two 10 out of 3 questions then point is 0.5 in the self-review

1 point if a 360 review was requested

2 points if a 360 feedback average matches within 2 points of your-self review on a any particular skill. 1 point if within 4 points.

3 Points if the Similarity Score index is over .8, 2 points if bet .5-.8, 1 point if bet .35-.49.

The scoring engine 133 then creates one or more individual competency grids 123 and/or institutional competency grids 124 having the top user intuitive skills 118 of the top and bottom performed based on the situational judgment questions. The company may then combine both the competency map of Item 5 and Item 12 to adjust for culture fitment across job roles. A learning individual 101A may then takes the benchmark test and now gets a fitment not only on the system benchmark but also based on the company combined competency map for culture fitment.

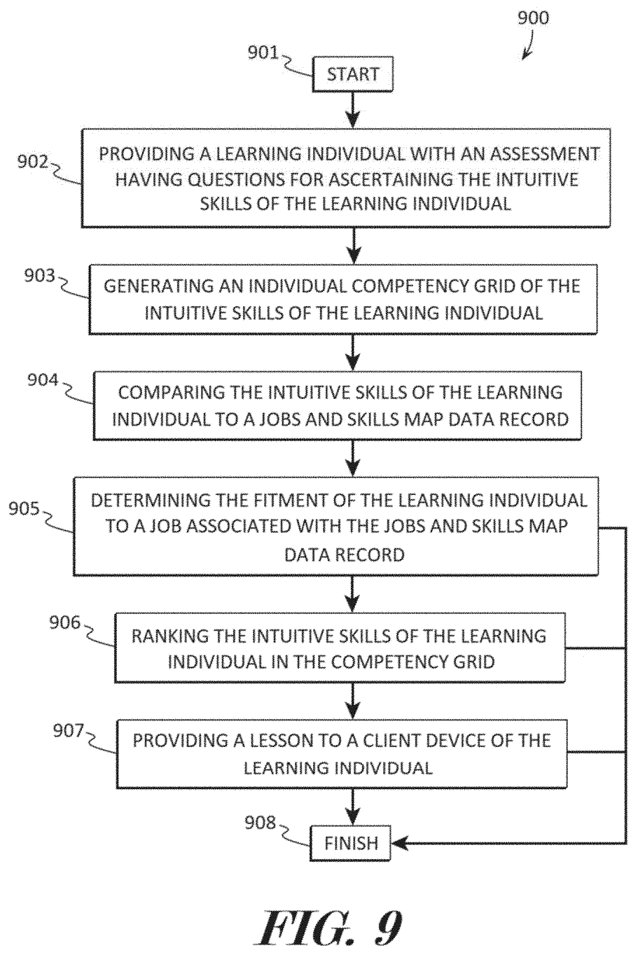

FIG. 9 depicts an example method of a computer implemented method of individual assessment (“the method”) 900 according to various embodiments. One or more steps of the method 900 may be performed by a communication engine 131, assessment engine 132, scoring engine 133, recommendation engine 134, and/or mapping engine 135 which may be executed by a computing device processor, such as a processor 302 (FIG. 2) and/or a processor 402 (FIG. 3).

In some embodiments, the method 900 may start 901 and a learning individual 101A may be provided with an assessment having questions for ascertaining the intuitive skills 118 of the learning individual 101A in step 902. For example, the learning individual 101A may be provided with a British Psychology Approved Benchmark or any other assessment or ascertaining the intuitive skills 118 of the learning individual 101A. In some embodiments, questions evaluating the intuitive skills 118 of the learning individual 101A may be provided to one or more peers 101B.

In step 903, an individual competency grid 123 may be generated with the intuitive skills 118 of the learning individual 101A. Preferably, a scoring engine 133 may be configured to generate an individual competency grid 123 (a compentency grid showing intuitive skills 118 of a single learning individual 101A) using the individual's 101A intuitive skills 118 scores 125 as shown in FIG. 6A. In preferred embodiments, the system database 110 may comprise an individual competency grid 123 for each learning individual 101A which may comprise a listing of two or more intuitive skills 118 of the learning individual 101A and a measurement or score 126 for each intuitive skill 118.

In step 904, the intuitive skills 118 of the learning individual 101A may be compared to a jobs and skills map data record 120. Generally, a jobs and skills map 120 may comprise one or more jobs 121 associated with one or more job intuitive skills 122 and a score 126 preferably for each job intuitive skill 122 associated with each job 121. A job data record (“job”) 121 may comprise information describing a job, position, role, occupation, task, and the like, which a person, such as a user 101, may perform. An intuitive skill data record (“job intuitive skill”) 122 may comprise information describing an intuitive skill 122 which may be used and/or not used by an individual performing that job 121. Preferably, the score 126 for each intuitive skill 122 of a job 121 may describe a threshold value or minimum value that a user intuitive skill 118 score 125 should preferably meet or exceed to successfully perform the job 121. The recommendation engine 134 may compare the intuitive skills 118 of the learning individual 101A to the jobs and skills map data record 120.

In step 905, the fitment of the learning individual 101A to a job 121 associated with the jobs and skills map data record 120 may be determined. The recommendation engine 134 may output a report showing how the learning individual's 101A intuitive skills 118 are below, equal to, and/or above the job intuitive skills 122 of that job 121 using the jobs and skills map data records 120 of the job 121. After step 905, the method 900 may continue to step 906 and/or 907 or may finish 908.

In optional step 906, the intuitive skills 118 of the learning individual 101A may be ranked in the individual competency grid 123 as shown in FIG. 6A, such as by the skills 118 having the highest scores 125 being listed before the skills 118 having the lowest scores 125. After step 906, the method 900 may continue to step 907 or may finish 908.

In optional step 907, a lesson 111, activity 112, and/or quiz 113 may be provided to a client device 400 of the learning individual 101A based on the intuitive skills 118 of the learning individual 101A. In some embodiments, a push notification may be provided to the client device 400 of the learning individual 101A in which the push notification notifies the learning individual 101A that the lesson is available for completion. In further embodiments, the lesson may be available to the client device 400 of the learning individual 101A for a limited period of time, such as for one day, one week, etc. In further embodiments, the learning individual 101A may have a limited period of time to interact with the lesson on the client device 400. After step 907, the method 900 may finish 908.

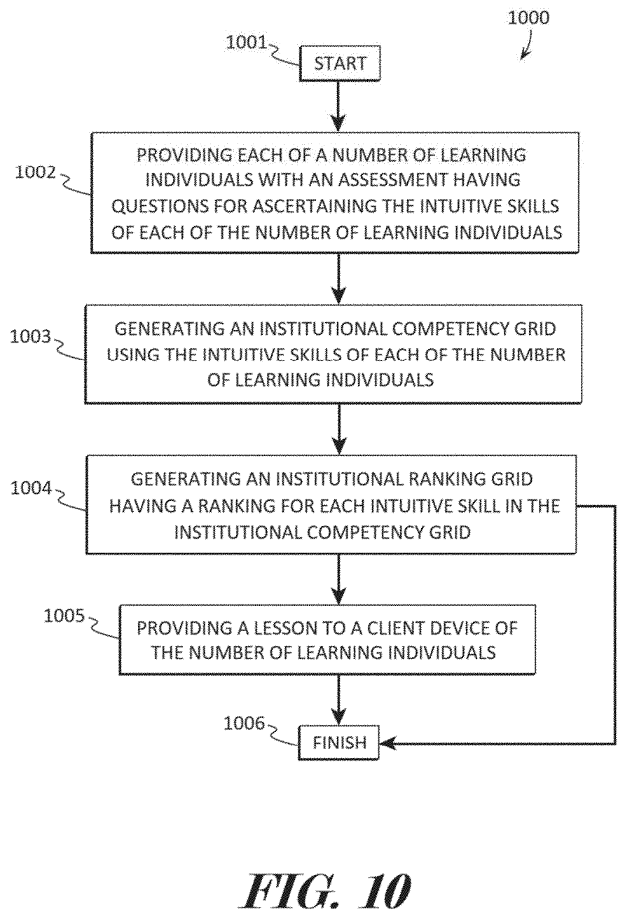

FIG. 10 illustrates an example of a computer implemented method of individual assessment (“the method”) 1000 according to various embodiments. One or more steps of the method 1000 may be performed by a communication engine 131, assessment engine 132, scoring engine 133, recommendation engine 134, and/or mapping engine 135 which may be executed by a computing device processor, such as a processor 302 (FIG. 2) and/or a processor 402 (FIG. 3).

In some embodiments, the method 1000 may start and a number of learning individuals 101A may be provided with an assessment having questions for ascertaining the intuitive skills 118 of each of the number of learning individuals 101A in step 1002. For example, the learning individuals 101A may be provided with a British Psychology Approved Benchmark or any other assessment or ascertaining the intuitive skills 118 of the learning individuals 101A. In some embodiments, questions evaluating the intuitive skills 118 of the learning individuals 101A may be provided to one or more peers 101B.

In step 1003, an institutional competency grid 124 may be generated using the intuitive skills 118 of each of the number of learning individuals 101A. Preferably, a scoring engine 133 may be configured to generate an institutional competency grid 124 (a compentency grid showing intuitive skills 118 of more than one learning individual 101A) using the individuals' 101A intuitive skills 118 scores 125 as shown in FIG. 6B. In some embodiments, the intuitive skills 118 of each of the number of learning individuals 101A may be compared to one or more job intuitive skills 122 of a jobs and skills map data record 120.

In step 1004, an institutional ranking grid 127 having a ranking 128 for each intuitive skill 118 in the institutional competency grid 124 may be generated by the scoring engine 133. In some embodiments, a scoring engine 133 may generate an average organization score or ranking 128 for each intuitive skill 118 and/or category of intuitive skills 118 of the one or more learning individuals 101A in the institutional competency grid 124. In further embodiments, the ranking 128 for each intuitive skill 118 may be generated by averaging the intuitive skills 118 of at least two learning individuals 101A of the institutional competency grid 124. After step 1004, the method 100 may continue to step 1005 or may finish 1007.

In optional step 1005, a learning pathway 119, optionally comprising a lesson 111, activity 112, and/or quiz 113 may be provided to a client device 400 of at least one of the learning individual 101A based on the intuitive skills 118 of one or more of the learning individuals 101A. In preferred embodiments, a learning pathway may comprise at least one of: a lesson 111 for the lowest intuitive skill 118 of a learning individual 101A, an activity 112 for the lowest intuitive skill 118 of a learning individual 101A, and a quiz 113 for the lowest intuitive skill 118 of a learning individual 101A. In some embodiments, a push notification may be provided to one or more client devices 400 of one or more of the learning individuals 101A in which the push notification notifies the one or more learning individuals 101A that the lesson is available for completion. In further embodiments, the lesson may be available to one or more of the client devices 400 of one or more of the learning individuals 101A for a limited period of time, such as for one day, one week, etc. In further embodiments, one or more of the learning individuals 101A may have a limited period of time to interact with the lesson on the client device 400. After step 1005, the method 1000 may finish 1006.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), light emitting diode (LED) display, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random-access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD), light emitting diode (LED) display, or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or WiFi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device or client device such as a personal digital assistant (PDA), laptop computer, tablet computer, smartphone, or cellular telephone. The LAN communications network and the other communications networks such as cellular wireless and Wi-Fi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A computer-implemented individual assessment method, the method comprising the steps of:
providing a learning individual with an assessment having questions for ascertaining the intuitive skills of the learning individual;
generating an individual competency grid of the intuitive skills of the learning individual;
comparing the intuitive skills of the learning individual to a jobs and skills map data record; and
determining the fitment of the learning individual to a job associated with the jobs and skills map data record.

2. The method of claim 1, further comprising the step of ranking the intuitive skills of the learning individual in the competency grid.

3. The method of claim 1, further comprising the step of providing a lesson to a client device of the learning individual.

4. The method of claim 4, wherein a push notification is provided to the client device of the learning individual, the push notification notifying the learning individual that the lesson is available for completion.

5. The method of claim 4, wherein the lesson is available to the client device of the learning individual for a limited period of time.

6. The method of claim 4, wherein the learning individual has a limited period of time to interact with the lesson on the client device.

7. The method of claim 1, wherein the jobs and skills map data record comprises at least one job intuitive skill associated with a job.

8. The method of claim 1, wherein questions evaluating the intuitive skills of the learning individual are provided to a peer.

9. The method of claim 1, wherein a learning pathway is generated based on the intuitive skills of the learning individual.

10. The method of claim 8, wherein the learning pathway comprises at least one of: a lesson, an activity, and a quiz.

11. A computer-implemented candidate assessment method, the method comprising the steps of:
providing each of a number of learning individuals with an assessment having questions for ascertaining the intuitive skills of each of the number of learning individuals;
generating an institutional competency grid using the intuitive skills of each of the number of learning individuals; and
generating an institutional ranking grid having a ranking for each intuitive skill in the institutional competency grid.

12. The method of claim 11, wherein the ranking for each intuitive skill is generated by averaging the intuitive skills of at least two learning individuals.

13. The method of claim 11, wherein the intuitive skills of each of the number of learning individuals are compared to a job intuitive skill of a jobs and skills map data record.

14. The method of claim 11, further comprising the step of providing a lesson to a client device of the number of learning individuals.

15. The method of claim 14, wherein a push notification is provided to a client device of the number of learning individuals, the push notification notifying the learning individuals that the lesson is available for completion.

16. The method of claim 14, wherein the lesson is available to a client device of the number of learning individuals for a limited period of time.

17. The method of claim 11, wherein questions evaluating the intuitive skills of the number of learning individuals are provided to a peer.

18. The method of claim 11, wherein a learning pathway is generated based on the intuitive skills of the learning individual.

19. The method of claim 19, wherein the learning pathway comprises at least one of: a lesson, an activity, and a quiz.

20. The method of claim 19, wherein the learning pathway comprises at least one of: a lesson for the lowest intuitive skill of the learning individual, an activity for the lowest intuitive skill of the learning individual, and a quiz for the lowest intuitive skill of the learning individual.
